(19) United States
(12) Patent Application Publication
(10) Pub. No.: US 2013/0196028 A1
(43) Pub. Date: Aug. 1, 2013

(54) CHICKPEA PREPARATION AND USES THEREOF

(71) Applicants: Shmuel Marko, Doar-Na Lev HaSharon (IL); Ascher Shmulewitz, Tel-Aviv (IL)

(72) Inventors: Shmuel Marko, Doar-Na Lev HaSharon (IL); Ascher Shmulewitz, Tel-Aviv (IL)

(73) Assignee: CLEARFARMA INDUSTRIES LTD., Bnei-Brak (IL)

(21) Appl. No.: 13/577,566

(22) PCT Filed: Feb. 6, 2011
(86) PCT No.: PCT/IL2011/000129

§ 371 Date: Apr. 3, 2013

Related U.S. Application Data
(60) Provisional application No. 61/302,136, filed on Feb. 7, 2010.

(51) Int. Cl. A23L 1/20

(52) U.S. Cl. CPC A23L 1/2008
USPC 426/46; 426/634; 426/598

(57) ABSTRACT

A chickpea soluble fraction enriched with nutritional components and a method of producing same are provided. The method producing a chickpea preparation enriched with nutritional components includes mechanically disrupting chickpea seeds to produce a chickpea suspension and enzymatically treating said chickpea suspension with one or more of: a protease, an amylase and a phytase. The method for includes isolating a soluble fraction from said chickpea suspension thereby producing the chickpea preparation enriched with nutritional components.

### RELATED APPLICATION

This application claims the benefit of priority of U.S. Provisional Patent Application No. 61/302,136 filed Feb. 7, 2010 and PCT Patent Application PCT/US2011/000129 filed Feb. 6, 2011, the contents of which are incorporated herein by reference in their entirety

### FIELD AND BACKGROUND OF THE INVENTION

The present invention relates to a chickpea preparation which can be in infant formulas as well as other ingestible compositions.

Infant formula is an ingestible composition which supports adequate growth of infants as a sole source of nutrition. Commonly used infant formulas contain purified cow's milk whey and casein as a protein source, a blend of vegetable oils as a fat source, lactose as a carbohydrate source, a vitamin-mineral mix, and other ingredients depending on the manufacturer.

Although use of cow milk-based formulas is widespread, more than 5% of infants are allergic to cow milk protein and thus must be fed a vegetable-based substitute.

The most common vegetable-based formula is based on soybean. Although soy-based formulas reduce the likelihood of allergies, babies allergic to cow's milk may also be allergic to soy milk. In addition, soy based formulas contain plant estrogen-like compounds (phytoestrogens) which may adversely affect infant development. Although there is no conclusive evidence showing short term affects on adults, it has been suggested that exposure of infants to phytoestrogen may have long-term harmful effects.

Another option to cow milk-based formulas are protein hydrolysate formulas (also known as hypoallergenic formulas) which are based on partially or extensively hydrolysed whey, casein or bovine collagen. Protein hydrolysate formulas are easier to digest and less likely to cause allergic reactions than cow milk or soy formulas. However, the nutritional value of protein hydrolysates is still under debate since few studies directly addressed nutritional value as a study outcome.

Attempts to address the limitations of milk, soy and protein-based formulas have led to the development of chickpea-based formulas.

Chickpeas are considered suitable for infant formulas due to their high nutritional value. However, since chickpeas contain anti-nutritionals such as protease inhibitors, amylase inhibitors, phytic acid, polyphenols, and oligosaccarides, use thereof in infant formulas requires processing in order to reduce or remove such anti nutritionals and enhance the digestibility and solubility of chickpea components.

Prior art methods of processing chickpeas typically include a step of extraction, filtration or enyzymatic treatment in order to reduce or remove insoluble and/or anti-nutritional components. Although such steps can enhance the digestibility and solubility of the resulting preparation, they can also result in a substantial reduction in nutritional protein content.

While reducing the present invention to practice, the present inventors have devised a novel chickpea processing approach that enhances the digestibility and solubility of the resulting preparation while maintaining most of the nutritional components of the chickpea.

### SUMMARY OF THE INVENTION

The invention thus provides a method for producing a composition comprising chickpeas, wherein the composition is free of isoflavones, gluten, lactose, phytate, oligosaccharides and other anti-nutritional factors.

The invention further provides a composition comprising chickpeas, wherein the composition is free of isoflavones, gluten, lactose, phytic acid, oligosaccharides and other anti-nutritional factors obtainable by a method of the invention, with the addition of cysteine (up to 0.08%, preferably 0.04%) and adjustment of pH with NaOH (up to 0.08%) during all processing stages.

The invention further involves a processed formula comprising chickpeas, wherein the formula is free of isoflavones, gluten, lactose, phytic acid, oligosaccharides and other anti-nutritional factors, elimination of insoluble residues (mainly fibers).

The invention further involves a processed formula comprising chickpeas, wherein the formula is free of isoflavones, gluten, lactose, phytic acid, oligosaccharides and other anti-nutritional factors, degradation of starch to soluble dextrin.

The invention further provides a composition comprising chickpeas, wherein the composition is free of isoflavones, gluten, lactose, phytic acid, oligosaccharides and other anti-nutritional factors obtainable by a method of the invention, solubilization of proteins partial hydrolization and cracking of bonds of phytic acid to enhance digestibility and decrease allergenic potential.

The invention further provides a method for producing a chickpea composition free of isoflavones, gluten and lactose, phytic acid, oligosaccharides and other anti-nutritional factors, and including at least 20% protein and exhibiting 60% or more solubility.

The present invention successfully addresses the shortcomings of the presently known configurations by providing specific steps of enzymatic interventions. The first step is aimed to expose the protein for further enzymatic action (proteases). The second stage involves deactivation of anti-nutritional factor (phytase). The third step is target to digest the protein and enhance its solubility.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow chart illustrating a method of preparing the composition of the present invention.

FIG. 2 illustrates in more detail stage 6 of the method illustrated in FIG. 1.

### DESCRIPTION OF THE PREFERRED EMBODIMENTS

The present invention is of a chickpea preparation which can be used as a basis for infant formulas, nutraceuticals and other ingestible compositions.

The principles and operation of the present invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology, values and ranges of values, and terminology employed herein is for the purpose of description and should not be regarded as limiting.

Chickpeas preparations are suitable for use in, for example, infant formulas due to their high nutritional value, low allergenic potential and low phytoestrogen content.

However, use of chickpea preparations in ingestible compositions such as infant formulas necessitates removal of anti-nutritional components from the chickpeas such as phytic acid which can chelate iron and oligosaccharides such as raffinose and stachyose which are indigestible and flatus forming.

Although the prior art describes several approaches for removing anti-nutritionals from chickpea preparations, such approaches could result in undesired loss of nutritional components (e.g. proteins, starch) which are trapped in, or adhered to, the removed carbohydrate components.

Following the above mentioned process, product analysis showed no substantial loss of protein during chickpea processing using current invention (with one exemplary embodiment providing that 22% protein was obtained at the end of the process, starting material included −25% protein w/w).

In order to overcome the limitations of prior art approaches, the present inventors have devised a novel chickpea processing approach which can be used to produce a chickpea preparation optimized for use in infant formulas and other ingestible compositions. As is clearly illustrated in the Examples section which follows, such a chickpea processing approach reduces the content of anti-nutritional components and yet maintains nutritionally important protein and carbohydrate components, as well as vitamins, minerals and other soluble components. In addition, the processing approach of the present invention provides such components in a soluble form thereby greatly facilitating use thereof in liquid-based compositions (e.g. infant formulas).

Thus according to one aspect of the present invention there is provided a method of producing a soluble chickpea fraction highly enriched with nutritional components.

The chickpea (Cicer arietinum) [also garbanzo bean, Indian pea, ceci bean, bengal gram, Chana, Kabuli chana (the larger variety only), Harbharaa, konda kadalai, kadale kaalu, sanaga pappu, shimbra, Kadala] utilized by the present invention can be of any variety, preferred are the Spanish-Kabuli, 3279 Kabuli, Desi 1408S5, Desi 8631, Hadas-Kabuli, Desi 8575, Raz, Vardit, Bar or Yarden varieties.

The present processing approach was developed while considering the following guidelines:

generate a chickpea soluble fraction enriched for proteins, fats, starch, minerals and vitamins while minimizing the loss of such components during processing;

remove insoluble components that provide no nutritional value (e.g. fibers);

remove or reduce anti-nutritional and potentially harmful components (e.g. phytic acid, oligosaccharides);

obtaining a solubility of at least 60%.

obtaining a protein content of at least 90% as compared to starting material (e.g. a final protein content of 20% or more, whereas chickpea seeds contain approximately 20-25% protein by weight).

These guidelines enables one to obtain a dry preparation that is suitable for use in high grade food products such as baby formulas, cereals and the like.

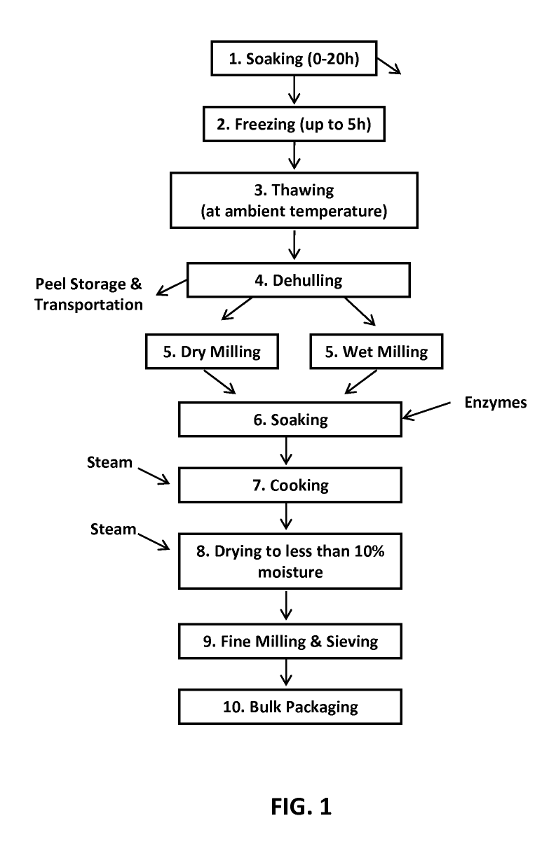

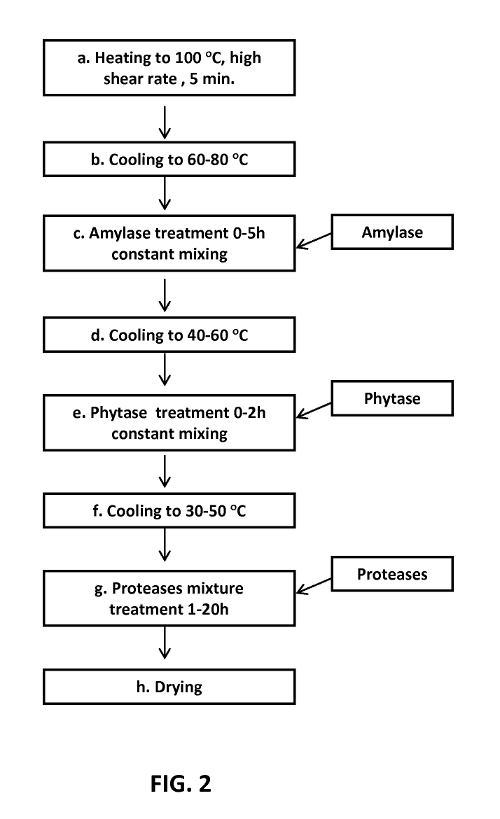

The following describes one preferred approach for producing the composition of matter of the present invention. This approach is also illustrated in FIGS. 1 and 2.

Whole chickpeas of any suitable variety are treated in order to remove the chickpea hulls by, for example, soaking them in water which includes NaOH and NaHCO3 (at concentration of 0.00-0.35% and 0.00-0.75% respectively in one exemplary embodiment) for a defined period of time, such as up to 24 hours at room temperature in one exemplary embodiment (Stage 1, FIG. 1).

NaOH (at a concentration of 0.0-0.30% per dry matter of chickpea w/w) and Cysteine (0.01-0.08% in one exemplary embodiment related to dry matter of chickpea) can be added at any stage in order to increase protein solubility.

The chickpeas are then frozen (up to 5 h, −20° C. in one exemplary embodiment) and thawed, in one embodiment thawing done at ambient temperature (Stages 2-3). This procedure increases protein solubility and reduces the allergenic potential of the preparation.

Chickpeas are then dehulled (stage 4 FIG. 1) and dry or wet—milled (Stage 5, FIG. 1) into a particulate chickpea preparation.

The chickpea preparation is then soaked, heated and enzymatically treated (Stage 6, FIG. 1) in order to solubilize the proteins. Stage 6 of FIG. 1 is described in more detail in FIG. 2.

Referring now to FIG. 2, the chickpea preparation resulting from stage FIG. 1, is heated to a first temperature, such as 80-100° C. in one exemplary embodiment for a defined period of time, such as 2-20 minutes in order to denature starches and proteins (Stage a, FIG. 2).

The resulting suspension is then cooled to a defined temperature, such as 60-80° C. (Stage b, FIG. 2) and enzymatically treated to degrade starch for up to minutes with constant mixing (Stage c, FIG. 2).

Following starch degradation, the suspension is cooled to another temperature, such as 40-60° C. (Stage d, FIG. 2) and Phytase is added for a period of time, such as 2 hours or less (Stage e, FIG. 2) in order to break down phytic acid. A protease mix is then added for another period of time, such as 20 hours or less in one exemplary embodiment (Stage g, FIG. 2). Thereafter, the suspension is left to dry, such as in one embodiment for a period of about 3 hours at a temperature of, for example, 95-180° C. (Stage h, FIG. 2). The drying can be done using any drying technique, such as, but not limited to, air drying, air circulation drying, ventilation. drying, spray drying, vacuum drying, foam-mat drying and film drying such as drying with drum dryer.

Since starch degradation facilitates release of phytic acid and proteins, sequential addition of amylase, phytase and proteases is necessary for optimal results. However, in order to simplify the procedure and enhance degradation, the proteases and optionally phytase can be added to the preparation along with the amylase. In such a case, these enzymes are preferably encapsulated by a carrier which protects the enzymes from degradation and possibly inhibitors and enables timed release thereof when the levels of their substrates are not reaction limiting.

Such a carrier can be degraded by the amylase to release the encapsulated enzymes. Amylase degradable carriers that can be used for timed release of protease(s) and phytase can include cross-linked starch (see U.S. Pat. No. 6,607,748).

Having a protease present in the preparation while the amylase is still active can help reduce any residual amylase inhibitor proteins/polypeptides still present in the preparation

Turning back to FIG. 1, following enzymatic degradation, the mixture is cooked for to deactivate the enzymes (Stage 7, FIG. 1). Insoluble fiber components are then centrifuged or filtered out and the preparation can then be dried (using steam, spray drying, drum drying or freeze drying) to a low moisture content, such as a moisture content of 10% or less in one exemplary embodiment, sieved and bulk packaged (stages 8-10).

The resulting composition (wet or dry soluble fraction) can then be used as a basis for infant formulas, nutraceuticals or pharmaceutical compositions, as is described below.

One of the main advantages of the soluble composition of the present invention is substantial improvement in protein digestibility as compared to prior art chickpea preparations. The present composition provides 60% protein solubility which is substantially higher than prior art preparations which typically provide 20% protein solubility. In addition, as is illustrated in the Examples section which follows, the protein fraction of the present preparation exhibits a typical SDS-PAGE gel electrophoresis separation pattern when compared to chickpea protein fractions obtained via prior art approaches.

As such, the chickpea preparation produced by the method of the present invention can be used to provide nutrition to populations suffering from malnutrition as well as provide nutrition to aged and infirmed individuals, hospital patients, babies and the like.

Thus, the present invention provides a novel approach for processing chickpeasfor use in soluble preparations. As is illustrated in the Examples section which follows, use of the unique combination of homogenization, enzymatic treatment and separation steps of the present methodology yielded a soluble chickpea fraction that includes over 75% of the nutritional components of the chickpea and less than 20% of the non-nutritional components (e.g. fibers).

Thus according to another aspect of the present invention there is provided a composition of matter that includes a soluble chickpea fraction containing over 75% of the nutritional components of the chickpea and less than 20% of the non-nutritional components.

The present composition of matter can be used to produce any ingestiblecomposition including, for example, infant formulas, neutraceuticals and pharmaceutical compositions. The soluble chickpea fraction of the present invention can be used in liquid form (as a solution in water) or as a dried powder (which can be further refined via milling) The Examples below describe three preferred uses for the present composition of matter.

As used herein the term “about” refers to ±10%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Example 1

Evaluation of the specific and combined effects of mechanical, thermal and chemical (cysteine/Na011) treatment on the amount of solubilized solids

Methodology

(i) Soaking (10% whole chickpea, 0,7% NaHCO3, 0,2% NaOH, 89% water) 20 hrs

(ii) (optional) freezing and thawing

(iii) Dehulling

(iv) Wet grinding 15 (v)

(v) Heating (100° C., min, high shear-rate)

(vi) Cooling to 70° C.

(vii) Addition of amylase (reaction time: 2 hrs, high shear-rate)

(viii) Cooling to 55° C.

(ix) Addition of phytase (reaction time: 30 min, high shear-rate)

(x) Cooling to 50° C.

(xi) Addition of protease—reaction time: 16 hrs. At this stage the process was split into different treatments with optional addition of NaOH, Cysteine.

(xii) Centrifugation and separation into liquid part and sediment

(xiii) Freeze-drying of liquid part

### RESULTS

The effect of the treatment was mainly evaluated with respect to percentage of solubilized dry matter (DM) and calculated as follows:

% solubilized DM=DM liquid part×100/(DM liquid part+DM sediment)

Table 1 below provides a summary of the results.

TABLE 1
Overview of process conditions and results

| | | | | | | % |
|---|---|---|---|---|---|---|
| | | | High | | | solubilized |
| | Trial | Freezing | shear-rate | NaOH | Cysteine | DM |
| 1 | CO | | No | | | 46 |
| basic | C1 | No | No′ | 0.08% | | 62 |
| batch | C2 | No | No′ | 0.08% | 0.08% | 63 |
| | C3 | No | High- | | | 58 |
| | | | pressure- | | | |
| | | | homogenizer | | | |
| | C4 | No | Becomix² | | | 59 |
| 1 | C5 | No | No′ | 0.08% | | 64 |
| basic | C6 | No | No′ | 0.08% | 0.08% | 52 |
| batch | C7 | No | No′ | | 0.04% | 58 |
| | C8 | No | No′ | | 0.08% | 56 |
| | C9 | No | Becomix² | 0.08% | 0.08% | 64 |
| 1 | C10 | No | Becomix² | | | 57 |
| basic | C11 | No | No′ | | | 57 |
| batch | C12 | Yes | Becomix² | | | 60 |
| | C13 | Yes | No′ | | | 59 |

′Stirring in water bath
²Rotor-stator-homogenizer

### CONCLUSIONS

NaOH, Cysteine and homogenization increase the percentage of soluble DM, freezing has a positive effect on % solubilized dry matter (DM). Cysteine at 0.08% is excessive, the final product has an unpleasant odor.

On the basis of these results the product was prepared for an allergenicity test using the basic preparation process and the following specific treatments:

Freezing/thawing

High shear-rate (Becomix)

0.08% NaOH

0.04% Cysteine

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of producing a chickpea preparation enriched with nutritional components comprising:
mechanically disrupting chickpea seeds to produce a chickpea suspension;
enzymatically treating said chickpea suspension with one or more of: a protease, an amylase and a phytase; and
isolating a soluble fraction from said chickpea suspension thereby producing the chickpea preparation enriched with nutritional components.

2. The method of claim 1, further comprising drying said soluble fraction.

3. The method of claim 1 further comprising increasing a cysteine percentage amount.

4. The method of claim 1 further comprising heating said suspension so as to denature starches and proteins present therein.

5. The method of claim 1 further comprising incubating said suspension with said phytase while mixing said suspension so as to break down phytic acid.

6.-8. (canceled)

9. A chickpea based soluble food source soluble fraction produced by a process comprising:
mechanically disrupting chickpea seeds to produce a chickpea suspension;
enzymatically treating said chickpea suspension with one or more of: a protease, an amylase and a phytase; and
isolating a soluble fraction from said chickpea suspension thereby producing the chickpea preparation enriched with nutritional components.

10. The chickpea based soluble food source of claim 9, wherein the process further comprises drying said soluble fraction.

11. The chickpea based soluble food source of claim 9, wherein the process further comprises increasing cysteine percentage amount.

12. The chickpea based soluble food source of claim 9, wherein the process further comprises heating said suspension so as to denature starches and proteins present therein.

13. The chickpea based soluble food source of claim 9, wherein the process further comprises incubating said suspension with said phytase while mixing said suspension so as to break down phytic acid.

14. The method of claim 1 further comprising:
inserting the soluble fraction into infant formula.

15. The method of claim 1 further comprising:
inserting the soluble fraction into food consumables.

16. The chickpea based soluble food source of claim 9 added to infant formula.

17. The chickpea based soluble food source of claim 9 added to food consumables.
